(19) United States
(12) Patent Application Publication
(10) Pub. No.: US 2009/0140051 A1
(43) Pub. Date: Jun. 4, 2009

(54) METHOD, DEVICE AND SYSTEM FOR OFF OPTICAL AXIS ILLUMINATION

(76) Inventor: Sik Piu Kwan, Suwanee, GA (US)

Correspondence Address: PAUL W. MARTIN, NCR CORPORATION, LAW DEPT., 1700 S. PATTERSON BLVD., DAYTON, OH, 45479-0001, US

(21) Appl. No.: 11/948,537

(22) Filed: Nov. 30, 2007

(51) Int. Cl. G06K 7/10

(52) U.S. Cl. 235/462.42

(57) ABSTRACT

An apparatus, method and system to illuminate a bar code or other optical codes so that reflected specular light is directed away from the image capture device of an imaging scanner and so that diffuse light is directed toward the image capture device. This improves the probability that the bar code will be read on the first pass by the imaging scanner.

### TECHNICAL FIELD

An apparatus, method and system described herein relates generally to improvements to imaging bar code scanners. More particularly, the invention relates to improving the illuminating of a bar code or other optical code being scanned by the imaging bar code scanner.

### BACKGROUND

Bar code scanners are used in a wide variety of applications that rely on bar codes to store information. Industries such as retail, airline, self service, automotive, parcel delivery, pharmaceutical, healthcare and others use bar codes to provide inventory control, customer identification, item tracking and many others functions. Bar code scanners scan or read a bar code that is typically attached to or printed on an object. A typical bar code is comprised of a number of bars separated by spaces. Information is encoded on a bar code by varying the width of the bars and spaces. When a bar code is placed within the field of view of a bar code scanner, the scanner will detect and analyze the bars and spaces comprising the bar code and then decode the information encoded in the bar code. This operation is also called scanning or reading a bar code. Information encoded on a bar code usually takes the form of an alphanumeric number.

An imaging bar code scanner reads a bar code by capturing a digital image of the bar code and then processing the image to detect and read the bar code. It is very important that the bar code scanner successfully read the bar code on the first pass of the bar code by the scanner. A good first pass read of a bar code helps to maintain workflow and speeds up the checkout process. It also reduces stress on the person operating the scanner. This is particularly true if the operator is a customer operating a self-checkout terminal.

Unfortunately, the location of illumination devices used to illuminate a bar code in imaging bar code scanners can hinder the scanners ability to achieve a high first pass read rate. The illumination devices are typically positioned near the optical axis of the image scanner, which causes light to be projected nearly parallel to the optical axis. (The optical axis is the path used by the image capture device to view and capture an image of the bar code.) This geometry does not work well when the bar code label has a reflective or glossy finish. The glossy finish on the bar code generates a large amount of specular reflections that obscures all or parts of the bar code. When the specular reflections are directed toward the image capture device of the imaging scanner, it is difficult or in some cases impossible to read the bar code. What is needed is a way to reduce or eliminate specular reflections directed to an image capture device of an imaging bar code scanner.

### BRIEF DESCRIPTION OF THE DRAWINGS

FIG. 1 is a block diagram illustration of an embodiment of an image scanning system.

FIG. 2A is an illustration of an image scanner.

FIGS. 2B is a cross section illustration of a portion of the image scanner.

### DETAILED DESCRIPTION

In the following description, numerous details are set forth to provide an understanding of the claimed invention. However, it will be understood by those skilled in the art that the claimed invention may be practiced without these details and that numerous variations or modifications from the described embodiments are possible.

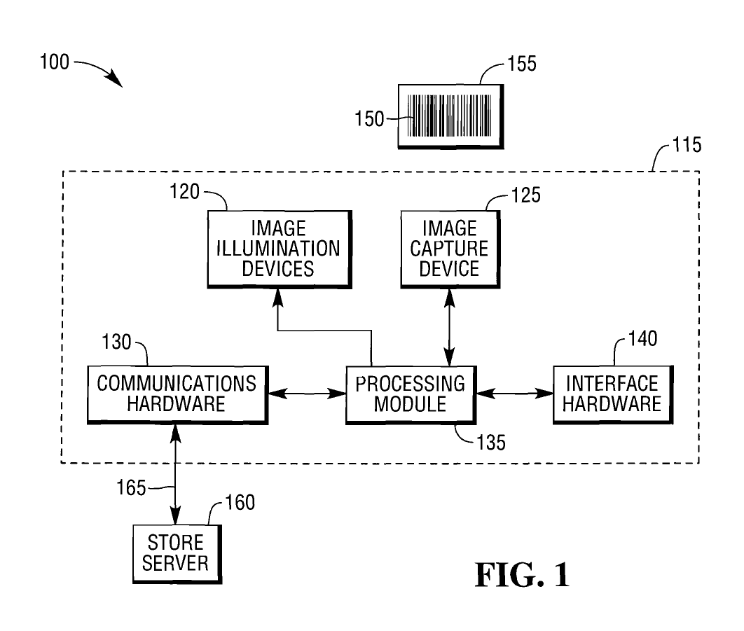

Referring now to FIG. 1, there is provided a high level illustration, in block form, of an embodiment of an image scanning system 100, which is used to scan a bar code 150 or other optical codes. The image scanning system 100 comprises an image scanner 115, a store server 160 and a bar code 150 printed on a bar code label 155. The image scanner 115 communicates with the store server 160 over a computer data network 165. The network 165 can be a wired network (e.g., an Ethernet network) or wireless network (e.g., an IEEE 802.11A/B/G or cellular based network) or a combination of these networks. In some embodiments, the store server 160 is physically removed from the store where the image scanner 115 is located and communicates with the image scanner 115 over the Internet or a wide area network or a combination of these or different types of networks. In some embodiments, multiple image scanners 115 communicate over the data network 165 to the store server 160.

The image scanner 115 includes one or more image illumination devices 120 that illuminate the bar code 150 and an image capture device 125 that captures an electronic image of the illuminated bar code 150. The image scanner 115 is further comprised of a processing module 135, interface hardware 140, and communications hardware 130. The processing module 135 comprises at least one processor, memory, stored instructions and hardware to control and interface with the other devices and modules of the image scanner 115. The processing module 135, by executing the stored instructions, controls the hardware devices and modules that comprise the image scanner 115 or are connected to the image scanner 115. In addition, the stored instructions cause the processor to: process images that have been captured by the image capture device 125 to read a bar code, control the communications hardware 130 to implement protocols used on the data network 165 and implement other software features and functions of the image scanner 115. In some cases, the store server 160 sends the image scanner 115 updates to the stored instructions or to the operating parameters of the image scanner 115.

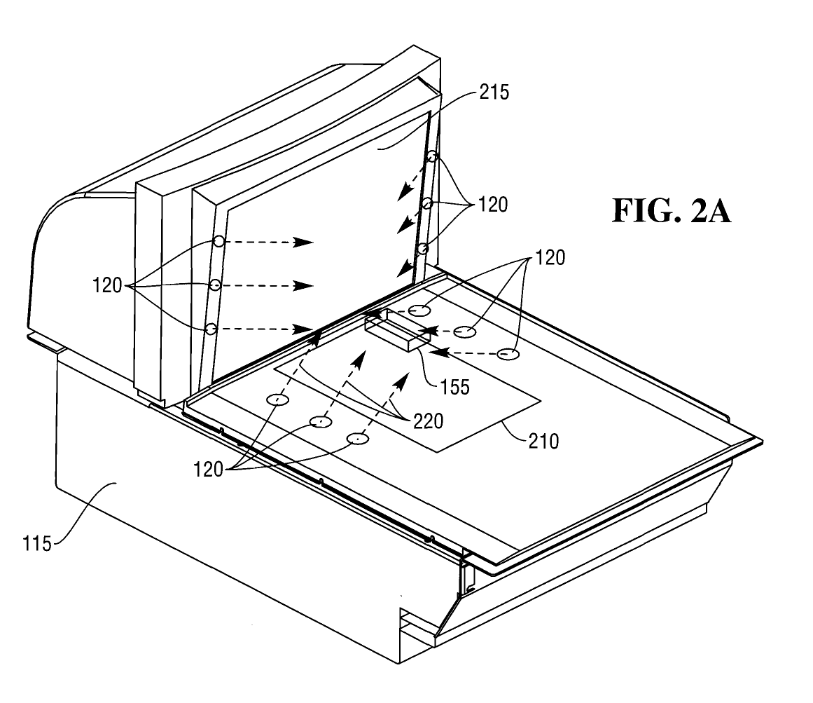

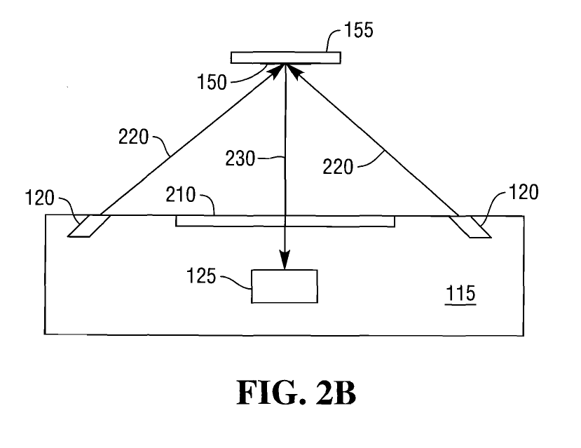

FIG. 2A is an illustration of an image scanner 115. In this embodiment, the image scanner 115 has a vertical scanning window 215 and horizontal scanning window 210 which are used to capture an image of the bar code label 155. In other embodiments, the image scanner 115 has only a vertical scanning window 215 or only a horizontal scanning window 210. In still other embodiments, the image scanner 115 is portable so that the scanning window can be placed in any orientation. The illumination devices 120 are located on either side of the horizontal scanning window 210 to illuminate the bar code label 155, which is facing the horizontal scanning window 210. Illumination devices 120 are also mounted on either side of the vertical scanning window 215 and they illuminate any objects facing the vertical scanning window 215. The illumination devices 120 are recessed mounted inside the image scanner 115 but can be mounted on the outside of the image scanner 115. In some embodiments, the illumination devices 120 are mounted inside the image scanner 115 so as to direct their light through the horizontal scanning window 210 and/or the vertical scanning window 215. In these cases, the windows must be wide enough to allow suffient distance between the illumination devices 120 and the optical axis. In this embodiment, the illumination devices 120 are Light Emitting Diodes (LED). In other embodiments, different types of illumination devices are used such as incandescent and florescent devices. In some embodiments, the illumination devices 120 are of the same type so that they produce the same wavelengths. In other embodiments, different types of illumination devices 120 are used in combination to produce different wavelengths of light.

FIG. 2B is an illustration of a cross section of the image scanner 115. The bar code label 155 is positioned over the horizontal window 210. The bar code 150 is printed on the lower surface of the bar code label 155, which is facing the horizontal scanning window 210. Illumination devices 120 are located on the right and left sides of the horizontal scanning window 210 and are aimed so as to illuminate any object placed over the horizontal window 210. Light 220 from the illumination devices 120 is directed to the bar code 150 and strikes the bar code at an angle. Diffuse light reflecting from the bar code 150 passes through the horizontal scanning window 210 onto the image capture device 125. The path between the bar code 150 and the image capture device 125 is referred to as an optical axis 230. An image scanner 115 will have on optical axis for each image capture device and by using optical components can have multiple optical axis for a single image capture device. Bar code labels that have a glossy or semi-glossy finish act like a mirror and reflect specular light. Specular light is bright glaring type of light that results in a very low contrast ratio for the image, which obscures all or parts of the bar code 150. Because the illumination devices 120 are located substantially away from the optical axis 230, the specular light reflecting off the bar code from the illumination devices 120 is directed away from the optical axis 230. The location of the illumination devices 120 eliminates or reduces the amount of specular light that is reflected to the optical axis 230 and the image capture device 125. The light that is reflected to the optical axis 230 is diffuse light, which has a much higher contrast ratio than the specular reflections, making it possible to read the bar code on the first pass.

The optimal orientation of the bar code 150 for being read by the imaging scanner 115 occurs when the bar code 150 is facing the optical axis 230 and aligned perpendicular to the optical axis 230 as shown in FIG. 2B. Through training and experience, users will attempt to achieve this orientation because it allows the highest probability of success for reading the bar code 150. However, the orientation of the bar code 150 to the illumination devices 120 and the optical axis will always vary from the optimal orientation because the object (and bar code 150) is being held and moved by a person. As a result, when the illumination devices 120 are positioned close to the optical axis 230, the minor variations in the orientation of the bar code 150 will cause specular reflections to be directed to the image capture device 125, which prevents or greatly lowers the probability of reading of the bar code 150. When the illumination devices 120 are positioned substantially away from the optical axis 230, the minor variations in the orientation of the bar code 150 are not suffient to cause the specular reflections to be directed to the image capture device 125. Therefore, the image scanner 115 will have a clear view of the diffuse reflected light from the bar code 150 and a high probability of reading the bar code 150.

This embodiment describes illumination devices 120 that are located on the right and left sides of the horizontal and vertical scanning windows (210 & 215). In some embodiments, the illumination devices 120 are located at the top and bottom of the scanning windows and in still other embodiments, the illumination devices 120 are located on all sides of each scanning window. In some embodiments, one or more illumination devices 120 are located inside the image scanner 115. Devices such as mirrors and/or light pipes are used to direct light generated by the one or more illumination devices 120 to the proper location on the image scanner 115 so that the light emerges from the image scanner 115 sufficiently removed from the optical axis. The mirrors or light pipes are also arranged direct the path of the light to an area where the bar code 150 passes by the image scanner 115.

In some embodiments, the image scanner 115 can to turn the illumination devices 120 on and off under program control. The processing module 135 controls each illumination device 120 and can turn each device off or on. When in a power saving mode, the processor turns off one or more of the illumination devices.

In some embodiments, the image scanner 115 is designed to read additional types of optical codes than just a bar code. These optical codes include text, numbers and symbols.

While the invention is disclosed in the context of an image bar code scanning embodiment, it will be recognized that a wide variety of implementations may be employed by a person of ordinary skill in the art consistent with the above discussion and the claims, which follow below.

What is claimed is:

1. A computer implemented method of reading an optical code by an optical image scanner, the method comprising:
illuminating the optical code with one or more illumination devices to produce reflected diffuse light containing an image of the optical code where the one or more illumination devices are positioned substantially off an optical axis of the image scanner causing specular light to be reflected away from the optical axis;
receiving the diffuse light reflected along the optical axis; and
capturing the image of the optical code contained in the reflected diffuse light.

2. The method of claim 1, where the optical code is a bar code.

3. The method of claim 1, where the illumination devices are LEDs.

4. The method of claim 1, further comprising turning off one or more of the illumination devices when the image scanner is in a power saving mode.

5. The method of claim 1, further comprising turning on one or more of the illumination devices when the image scanner exits a power saving mode.

6. An optical image scanning apparatus for illuminating and reading an optical code, the apparatus comprising:
an image capture device for capturing an image of the optical code where the path between the image capture device and the optical code form an optical axis;
one or more illumination devices positioned substantially off the optical axis and directed to illuminate the optical code so that light reflected from the optical code toward the image capture device is diffuse light and where specular light is reflected away from the image capture device; and
a processing module adapted to read a captured image of the optical code from the image capture device and to recover information encoded in the optical code.

7. The apparatus of claim 6, where the optical code is a bar code.

8. The apparatus of claim 6, where at least one of the illumination devices is an LED.

9. The apparatus of claim 6, where the processing module is further adapted to turn off one or more of the illumination devices when the image scanner is in a power saving mode.

10. The apparatus of claim 6, where the processing module is further adapted to turn on one or more of the illumination devices when the image scanner exits a power saving mode.

11. An image scanning system for reading an optical code, the system comprising:
a store server computer;
a network connected to the store server computer; and
an image scanner comprising:
an image capture device for capturing an image of the optical code where the path between the image capture device and the optical code form an optical axis;
one or more illumination devices positioned substantially off the optical axis and directed to illuminate the optical code so that light reflected from the optical code toward the image capture device is diffuse light and where specular light is reflected away from the image capture device; and
a processing module adapted to: read a captured image from the image capture device, process the captured image to recover the information from the optical code and send the information over the network to the store server.

12. The system of claim 11, where the optical code is a bar code.

13. The system of claim 11, where at least one of the illumination devices is an LED.

14. The system of claim 11, where the processing module is further adapted to turn off one or more of the illumination devices when the image scanner is in a power saving mode.

15. The system of claim 11, where the processing module is further adapted to turn on one or more of the illumination devices when the image scanner exits a power saving mode.
